(19) United States
(12) Patent Application Publication
(10) Pub. No.: US 2026/0339812 A1
(43) Pub. Date: Oct. 29, 2026

(54) Information Processing Method, Computer Program, and Information Processing Device

(71) Applicant: AGEST, Inc., Tokyo (JP)

(72) Inventors: Tsuyoshi Tanaka, Tokyo (JP); Ryuichi Sakamoto, Tokyo (JP); Kyosuke Kotani, Tokyo (JP); Hiroshi Yawata, Tokyo (JP); Kazuki Shimojima, Tokyo (JP); Yohei Takagi, Tokyo (JP)

(21) Appl. No.: 19/653,660

(22) Filed: Apr. 21, 2026

(30) Foreign Application Priority Data
Apr. 25, 2025 (JP) 2025-073238

(51) Int. Cl. G06F 11/34; G06F 16/334; G06F 16/34

(52) U.S. Cl. CPC G06F 11/3466; G06F 16/3347; G06F 16/345

(57) ABSTRACT

Provided are an information processing method, a computer program, and an information processing device that can be expected to support debugging work of an application program by a user. The information processing method according to the present embodiment causes an information processing device to execute the steps including: acquiring trace information and log information relating to execution of an application program to be tested; acquiring a source code of the application program; acquiring investigation content information indicating a content to be investigated regarding an error caused by execution of the application program; inputting the trace information, the log information, the source code, and the investigation content information that have been acquired to a language model; acquiring investigation result information output by the language model; and outputting the acquired investigation result information.

### CROSS-REFERENCE TO RELATED APPLICATIONS

This non-provisional application claims priority under 35 U.S.C. § 119(a) on Patent Application No.2025-073283 filed in Japan on Apr. 25, 2025, the entire contents of which are hereby incorporated by reference.

### BACKGROUND

The present disclosure relates to an information processing method, a computer program, and an information processing device.

JP 2021-177272 A proposes a debugging support device that collects test case data in which information regarding an execution state and an expected value of an execution result of each process of an application program are set, reproduces the execution state of each process of the application program based on the test case data, and determines the presence or absence of a defect in each process of the application program based on a result of comparison between the execution result of the process of the application program and the expected value.

### SUMMARY

An information processing method according to one embodiment causes an information processing device to execute the steps including: acquiring trace information and log information relating to execution of an application program to be tested; acquiring a source code of the application program; acquiring investigation content information indicating a content to be investigated regarding an error caused by execution of the application program; inputting the trace information, the log information, the source code, and the investigation content information that have been acquired to a language model; acquiring investigation result information output by the language model; and outputting the acquired investigation result information.

### BRIEF DESCRIPTION OF THE DRAWINGS

FIG. 1 is a schematic diagram for explaining an overview of an information processing system according to the present embodiment;

FIG. 2 is a block diagram illustrating a configuration example of a debugging server device according to the present embodiment;

FIG. 3 is a schematic diagram illustrating a display example of an investigation result by a user terminal device;

FIG. 4 is a block diagram illustrating a configuration example of a user terminal device according to the present embodiment;

FIG. 5 is a block diagram illustrating a configuration example of a testing server device according to the present embodiment;

FIG. 6 is a flowchart illustrating an example of a procedure of information collecting processing performed by the debugging server device according to the present embodiment; and

FIG. 7 is a flowchart illustrating an example of a procedure of investigation processing performed by the debugging server device according to the present embodiment.

### DETAILED DESCRIPTION

A specific example of an information processing system according to an embodiment of the present disclosure will be described below with reference to the drawings. The present disclosure is not limited to these illustrative examples, but is indicated by the claims, and is intended to include all modifications within the meaning and scope equivalent to the claims.

### System Overview

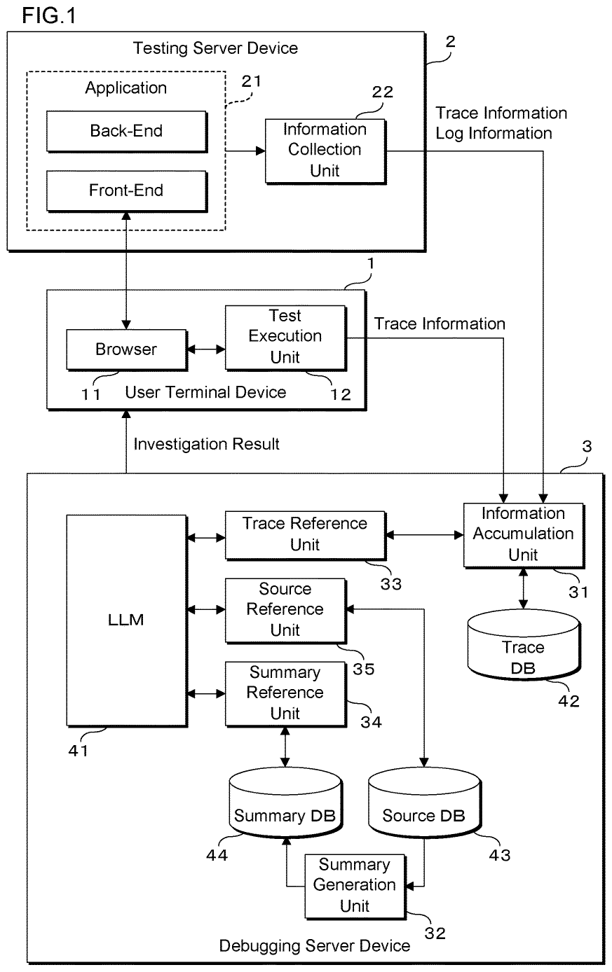

FIG. 1 is a schematic diagram for explaining an overview of an information processing system according to the present embodiment. The information processing system according to the present embodiment includes, for example, a user terminal device 1, a testing server device 2, a debugging server device 3, and the like. The user terminal device 1 is an information processing device such as a personal computer (PC), a smartphone, or a tablet terminal device, and is a device for a user to perform work such as creation and debugging of an application program. The testing server device 2 is an information processing device for executing an application program 21 to be tested. The debugging server device 3 is an information processing device for supporting debugging work of the application program 21 by the user, and performs processing such as specifying a cause of an error using an LLM (large language model) 41 based on information collected by execution of the application program 21.

In the present embodiment, a program for providing a service used by a user via a browser 11 is assumed as the application program 21 to be tested. The application program 21 includes, for example, a front-end program and a back-end program. The front-end program is a program that provides a user interface for exchanging information with the user, and displays information such as characters and images on the browser 11 and accepts an input operation by the user. The back-end program is a program that performs processing of data related to a service provided to the user, cooperation with an external service, and the like.

The user terminal device 1 according to the present embodiment includes a test execution unit 12. At the time of execution of the application program 21, the test execution unit 12 is intervening between the browser 11 and the front-end program of the application program 21 and acquires, as trace information, information input to the application program 21 and information output from the application program 21, that is, information regarding a test case for the application program 21 to be tested. The test execution unit 12 attaches a trace ID for identifying a test case to the acquired trace information and transmits the trace information to the debugging server device 3.

The testing server device 2 according to the present embodiment includes an information collection unit 22. The information collection unit 22 collects the trace information and the log information along with the execution of the application program 21 and transmits the trace information and the log information to the debugging server device 3. A target of the information collection by the information collection unit 22 may include both the front-end program and the back-end program of the application program 21, or may include only one of the front-end program and the back-end program.

The trace information collected by the information collection unit 22 can include, for example, information such as a function name of a function executed in the application program 21, a value of an argument passed to the function, a return value of the function, and an execution start time or an execution end time of the function. The trace information may also include, for example, information such as a value stored in a variable at the time of execution of the application program 21, data stored in a memory, a register, a stack, or the like, or data transmitted and received through communication with the outside. However, the trace information may include various information other than the above information.

The log information collected by the information collection unit 22 is information output (display, file output, or the like) in order to notify the user of contents of an error or the like in a case where the error or the like occurs due to execution of the application program 21. The log information may be, for example, information output by an execution environment of the application program 21, or may be, for example, information output by the application program 21 itself.

The debugging server device 3 according to the present embodiment is a device that accumulates information regarding the application program 21 to be tested and investigates the cause of an error using the LLM 41 based on the accumulated information. The debugging server device 3 includes three databases, for accumulating information, including a trace database (DB) 42, a source DB 43, and a summary DB 44. The trace DB 42 stores trace information transmitted from the test execution unit 12 of the user terminal device 1 and trace information and log information transmitted from the information collection unit 22 of the testing server device 2. The source DB 43 stores a source code (source program) of the application program 21 to be tested. In the present embodiment, the user who performs debugging work uploads a source code from the user terminal device 1 to the debugging server device 3 in advance. The summary DB 44 stores summary information of a program generated based on the source code of the application program 21 to be tested.

In addition, the debugging server device 3 according to the present embodiment includes an information accumulation unit 31, a summary generation unit 32, a trace reference unit 33, a summary reference unit 34, a source reference unit 35, and the like. The information accumulation unit 31 communicates with the user terminal device 1 and the testing server device 2 to acquire trace information collected by the user terminal device 1, and trace information and log information collected by the testing server device 2, and stores and accumulates the acquired information in the trace DB 42. The information accumulation unit 31 acquires, from the user terminal device 1, trace information to which a trace ID for identifying the test case is attached in execution of the application program 21 according to a predetermined test case, acquires the trace information and the log information that have been collected by the testing server device 2 along with the execution of the application program 21 for the test case, and stores the information in the trace DB 42 in association with the trace ID. As a result, the trace information and the log information related to the test case in which the error has occurred can be referred to based on the trace ID attached to the test case.

Based on the source code of the application program 21 to be tested stored in the source DB 43, the summary generation unit 32 generates information such as what kind of processing this source code performs as summary information. In the present embodiment, the summary generation unit 32 generates summary information of the source code using an LLM. The summary generation unit 32 stores the generated summary information in the summary DB 44. In the present embodiment, the summary DB 44 stores information obtained by vectorizing the summary information. The summary generation unit 32 vectorizes the generated summary information using an encoder that converts text information into vector information. Note that the generation of the summary information and the vectorization of the summary information by the summary generation unit 32 may use the LLM 41 used for an investigation of a cause of an error or the like, or may use an LLM different from the LLM 41, an encoder, or the like.

In the present embodiment, the debugging server device 3 generates the summary information from the source code using the LLM 41, but the present invention is not limited thereto. The debugging server device 3 may generate the summary information using a learning model different from the LLM, for example, or may generate the summary information from the source code by rule-based processing, for example. In addition, for example, the debugging server device 3 may accept an input of the summary information created by the user and store the input in the summary DB 44 instead of creating the summary information. The summary information may be created by any other method.

The trace reference unit 33 is intervening between the LLM 41 and the trace DB 42, and performs processing of acquiring trace information and log information necessary for an investigation by the LLM 41 from the trace DB 42. The trace reference unit 33 refers to the trace DB 42 based on the trace ID of the test case in which an error has occurred, reads trace information and log information for investigating a factor of the error, and provides the trace information and the log information that have been read to the LLM 41.

The summary reference unit 34 is intervening between the LLM 41 and the summary DB 44, and performs processing of acquiring summary information necessary for an investigation by the LLM 41 from the summary DB 44. The summary reference unit 34 reads the summary information of the related source code from the summary DB 44 based on, for example, the trace information and the log information that have been acquired by the trace reference unit 33, and provides the summary information to the LLM 41.

The source reference unit 35 is intervening between the LLM 41 and the source DB 43, and performs processing of acquiring a source code necessary for an investigation by the LLM 41 from the source DB 43. The source reference unit 35 reads the related source code from the source DB 43 based on, for example, the trace information and the log information that have been acquired by the trace reference unit 33, and provides the related source code to the LLM 41. Note that the source reference unit 35 reads, instead of all of the source code of the application program 21 to be tested, only a portion related to an error from the source DB 43 and provides the portion to the LLM 41. At this time, the source reference unit 35 can determine which source code is related to an error using the LLM 41 based on the summary information acquired by the summary reference unit 34 from the summary DB 44, and can acquire the source code determined to be related from the source DB 43.

As the LLM 41, a learning model such as a Transformer provided with an attention mechanism in a large-scale neural network, BERT (Bidirectional Encoder Representations from Transformers), or GPT (Generative Pre-trained Transformer) can be adopted, for example. The LLM 41 used by the information processing system according to the present embodiment may be a widely disclosed general-purpose large-scale language model, and may be obtained by causing the general-purpose large-scale language model to learn information regarding debugging of a program by fine tuning.

In the present embodiment, the debugging server device 3 includes the LLM 41, but the present invention is not limited thereto. The LLM 41 may operate in a server device or the like different from the debugging server device 3. The debugging server device 3 transmits and receives data to and from another server device including the LLM 41 using, for example, an application programming interface (API) for incorporating the LLM 41 into an application program, so that the debugging server device 3 can perform processing using the LLM 41 included in the other server device, similarly to a case where the debugging server device 3 itself includes the LLM 41.

For example, in such a case where an error occurs in the execution of the application program 21 to be tested, the debugging server device 3 according to the present embodiment investigates the factor of the error using the LLM 41 based on the information accumulated in the database. For example, the debugging server device 3 acquires the trace information and the log information from the trace DB 42 based on the trace ID of the test case in which the error has occurred, and acquires the source code and the summary information related to the trace information and the log information from the source DB 43 and the summary DB 44. In addition, the debugging server device 3 acquires, for example, investigation content information indicating what kind of investigation is to be performed regarding the error from the user via the user terminal device 1. The debugging server device 3 generates a prompt including information such as the trace ID of the test case in which the error has occurred and the investigation content information acquired from the user, and a command for an investigation of the factor of the error of the application program 21, and inputs the prompt to the LLM 41 together with the information acquired from the database. According to the provided prompt, the LLM 41 outputs text information including a result of the investigation of a factor of an error of the application program 21 based on the trace information, the log information, the source code, and the summary information that have been acquired from the database. The debugging server device 3 acquires the text information output by the LLM 41 and transmits the acquired text information to the user terminal device 1 as an investigation result of the error. The user terminal device 1 displays the text information of the investigation result received from the debugging server device 3 and presents the investigation result of a factor of the error to the user.

Note that, in FIG. 1, the information processing system includes three devices of the user terminal device 1, the testing server device 2, and the debugging server device 3, but the information processing system is not limited thereto, and may include two or less devices, or may include four or more devices. The example illustrated in FIG. 1 assumes a form in which the user uses a service provided by the application program 21 via the browser 11, but in a case where the application program 21 is executed by the user terminal device 1, for example, functions of the user terminal device 1 and functions of the testing server device 2 illustrated in FIG. 1 can be integrated into one device. In addition, for example, the execution of the application program 21 to be tested and investigation processing by the LLM 41 may be performed by one server device. In addition, for example, the processing of accumulating information in the database by the debugging server device 3 and the investigation processing by the LLM 41 may be performed by another server device, or, for example, three databases may be held by different server devices, respectively.

### Device Configuration

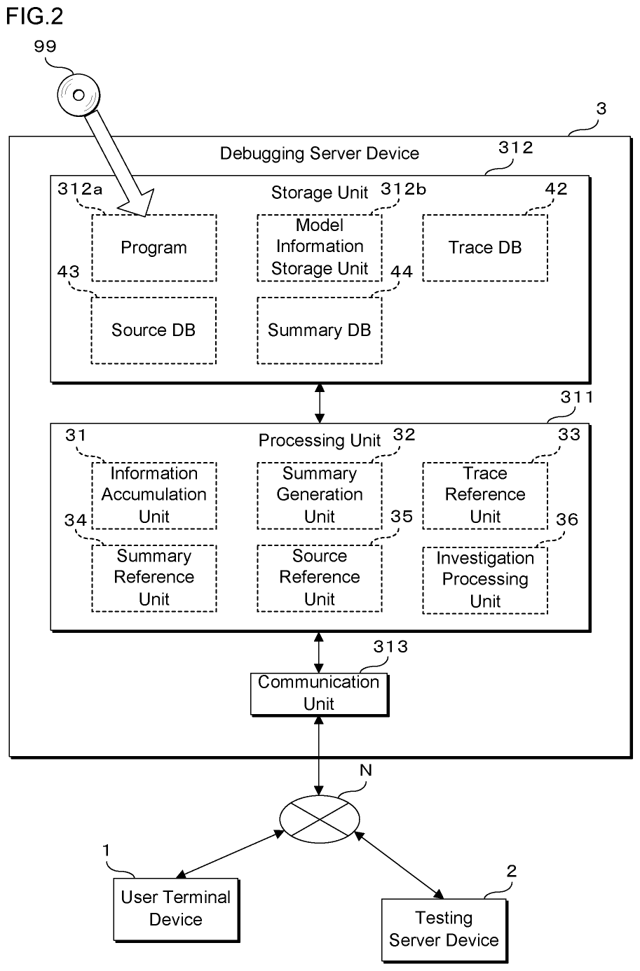

FIG. 2 is a block diagram illustrating a configuration example of the debugging server device 3 according to the present embodiment. The debugging server device 3 according to the present embodiment can be realized, for example, by installing the computer program according to the present embodiment in an information processing device such as a general-purpose server computer. The debugging server device 3 according to the present embodiment includes a processing unit (processor) 311, a storage unit (storage) 312, a communication unit (transceiver) 313, and the like.

The processing unit 311 is configured using an arithmetic processing unit, such as a central processing unit (CPU), a micro-processing unit (MPU), a graphics processing unit (GPU), neural network processing unit (NPU) or a quantum processor, and a storage device, such as a read-only memory (ROM) and a random-access memory (RAM). The processing unit 311 reads and executes a program 312a stored in the storage unit 312 to perform various processing such as processing for collecting trace information and log information of the application program 21 to be tested and processing for investigating a factor of an error based on the collected information.

The storage unit 312 is configured using a large-capacity storage device, for example, a hard disk or a solid state drive (SSD). The storage unit 312 stores various kinds of programs executed by the processing unit 311 and various kinds of data necessary for the processing of the processing unit 311. In the present embodiment, the storage unit 312 stores the program 312a that is executed by the processing unit 311. In addition, the storage unit 312 is provided with a model information storage unit 312b that stores information regarding a learned learning model subjected to machine learning in advance, that is, the LLM 41, and three databases of the trace DB 42, the source DB 43, and the summary DB 44 described above.

In the present embodiment, the program (computer program, program product) 312a is provided in a manner to be recorded in a recording medium 99, such as a memory card or an optical disc, and the debugging server device 3 reads the program 312a from the recording medium 99 and stores the program in the storage unit 312. The program 312a may otherwise be written in the storage unit 312, for example, at a manufacturing stage of the debugging server device 3. For example, the program 312a may be delivered by a remote server device or the like, and the debugging server device 3 may acquire the program 312a over communication. For example, the program 312a may be recorded in the recording medium 99, and a writing device may read and write the program 312a in the storage unit 312 of the debugging server device 3. The program 312a may be provided in a manner of delivery via a network or may be provided in a manner to be recorded in the recording medium 99.

The model information storage unit 312b stores information regarding various learning models generated in advance. The information regarding the learning model can include, for example, information indicating the configuration of the learning model and information such as values of predetermined internal parameters. In the present embodiment, the model information storage unit 12b stores information such as a model configuration and parameters for the LLM 41.

The trace DB 42 stores trace information and log information obtained at the time of execution of the application program 21 to be tested in association with a trace ID. The source DB 43 stores a source code of the application program 21 to be tested. The summary DB 44 stores information obtained by vectorizing summary information generated by the LLM 41 or the like based on the source code of the application program 21 to be tested.

The communication unit 313 communicates with other devices via a network N such as a local area network (LAN) or the Internet. In the present embodiment, the communication unit 313 communicates with the user terminal device 1 and the testing server device 2. For example, the communication unit 313 receives the trace information transmitted from the user terminal device 1 and the trace information and the log information transmitted from the testing server device 2, and provides the trace information and the log information to the processing unit 311. Furthermore, the communication unit 313 transmits the investigation result provided from the processing unit 311 to the user terminal device 1.

The storage unit 312 may be an external storage device that is connected to the debugging server device 3. The debugging server device 3 may be a multi-computer including a plurality of computers, or may be a virtual machine that is virtually constructed by software. The debugging server device 3 is not limited to the above configurations, and may include, for example, a reading unit that reads information stored in a portable storage medium, an input unit that accepts an operation input, a display unit that displays an image, or the like.

In the debugging server device 3 according to the present embodiment, the processing unit 311 reads and executes the program 312a stored in the storage unit 312, and as a result, the information accumulation unit 31, the summary generation unit 32, the trace reference unit 33, the summary reference unit 34, the source reference unit 35, the investigation processing unit 36, and the like are realized as software functional units in the processing unit 311. Note that, in the drawing, as the functional units of the processing unit 311, functional units related to processing of collecting the trace information and the log information of the application program 21 to be tested and processing of investigating a factor of an error based on the collected information are illustrated, and functional units related to other processing are not illustrated.

The information accumulation unit 31 communicates with the user terminal device 1 by the communication unit 313, receives the trace information transmitted by the user terminal device 1, and stores the received trace information in the trace DB 42 in association with the trace ID. Further, the information accumulation unit 31 communicates with the testing server device 2 by the communication unit 313, receives the trace information and the log information transmitted by the testing server device 2, and stores the trace information and the log information that have been received in the trace DB 42 in association with the trace ID.

The trace ID is assigned by the user terminal device 1 to the trace information. The association between the trace ID generated by the user terminal device 1 and the trace information and the log information that have been transmitted by the testing server device 2 may be performed by the testing server device 2 or may be performed by the debugging server device 3. For example, the user terminal device 1 can transmit the trace ID to the testing server device 2, and the testing server device 2 can attach the trace ID to the trace information and the log information and transmit the information to the debugging server device 3. Further, for example, the debugging server device 3 can associate trace ID based on the timing at which the trace information is received from the user terminal device 1 and the timing at which the trace information and the log information are received from the testing server device 2.

For example, in a case where the source code of the application program 21 to be tested is uploaded by the user and stored in the source DB 43, the summary generation unit 32 inputs the source code to the LLM 41 and provides a prompt including a command for generation of a sentence describing the summary of the source code to the LLM 41. The summary generation unit 32 acquires the summary information output by the LLM 41 in response to this prompt, and stores the acquired summary information in association with information such as a name or identification information of the application program 21 in the summary DB 44. In addition, in the present embodiment, the summary generation unit 32 vectorizes the summary information generated by the LLM 41 using an encoder or the like prepared in advance, and stores the vectorized summary information in the summary DB 44. Note that the processing of generating the summary information from the source code is not limited to the method performed using the LLM 41. For example, the summary generation unit 32 may generate the summary information by various methods such as automatically generating the summary information using a predefined rule or template.

For example, the summary generation unit 32 can generate the following summary information.
“
File name: SampleController.py
Summary:
File role: This is a controller for controlling operations and executing various actions (in particular, transmission of notification mails) based on changes in the state of target data.

Details of file processing: In the method, when the status is changed to “xxx”, the processing of acquiring the corresponding information and sending a notification mail is implemented.
”

The above summary information is an example of the summary information output by the LLM 41. In the present embodiment, the summary information is, for example, information expressed in a language that can be understood by the user, such as Japanese or English. However, the summary generation unit 32 stores information obtained by vectorizing summary information such as Japanese in the summary DB 44. Note that the summary DB 44 may store the vectorized summary information together with the summary information before vectorization. The above summary information is an example and is not limited thereto.

The trace reference unit 33 acquires a trace ID of a test case in which an error has occurred at the time of execution of the application program 21 to be tested, and acquires trace information and log information with reference to the trace DB 42 based on the acquired trace ID. The summary reference unit 34 acquires summary information of the related source code from the summary DB 44 based on the trace information and the log information that have been acquired by the trace reference unit 33. In the present embodiment, the summary DB 44 stores the vectorized summary information, and the summary reference unit 34 can acquire desired summary information by vectorizing the trace information and the log information and calculating the similarity with the vector information stored in the summary DB 44. The source reference unit 35 acquires the related source code from the source DB 43 based on the trace information and the log information that have been acquired by the trace reference unit 33 or the summary information acquired by the summary reference unit 34.

The investigation processing unit 36 investigates an error factor using the LLM 41 based on the trace information and the log information that have been acquired by the trace reference unit 33, the summary information acquired by the summary reference unit 34, and the source code acquired by the source reference unit 35. In the present embodiment, in a case where an error occurs at the time of execution of the application program 21 to be tested, the user terminal device 1 accepts an input of an investigation content related to the error from the user who performs debugging, and transmits the accepted investigation content to the debugging server device 3. The investigation processing unit 36 generates a prompt including a command for an investigation of the error of the application program 21 to be tested based on the investigation content received from the user terminal device 1 and the trace ID of the test case in which the error has occurred.

For example, the investigation processing unit 36 may generate the following prompt.
“
The trace ID in which the error has occurred and the contents desired to be investigated are provided. Based on the contents, check the code in which the problem occurs and investigate the cause.
Trace ID: {trace_id}
Investigation content: When you click on the update button, “Update failed” is displayed. Please investigate the reason.
”

The above prompt assumes a situation in which the application program 21 to be tested is a web application having a user registration function, a login function, or the like, and an error of “failed to update user information” occurs in response to the input of the test case. The first sentence of the above prompt “The trace ID in which the error has occurred and the contents desired to be investigated are provided. Based on the contents, check the code in which the problem occurs and investigate the cause.” is a predetermined statement. The actual trace ID is inserted into the portion of “{trace_id}” in the second sentence “Trace ID: {trace_id}”. Third sentence “Investigation content: When you click on the update button, “Update failed” is displayed. Please investigate the reason.” is an example of the investigation content input by the user. The investigation processing unit 36 can generate a prompt by inserting the trace ID, the investigation content information, and the like into a prompt form including a command sentence prepared in advance. It should be noted that the above prompt is an example, and the present invention is not limited thereto.

Note that, in the present embodiment, a configuration in which the user inputs the investigation content related to the error is adopted, but the present invention is not limited thereto. For example, the debugging server device 3 can generate a sentence of the investigation content using the LLM 41 based on the log information output when an error occurs. Further, for example, in a case where the log information includes information such as an error code indicating a type of the error or the like, the debugging server device 3 may generate a prompt with a sentence of a predetermined investigation content for the error code as the investigation content.

The investigation processing unit 36 configures the LLM 41 based on the information stored in the model information storage unit 312b, and inputs the generated prompt, and the trace information, the log information, the summary information, and the source code acquired from the database to the LLM 41. The LLM 41 investigates a factor of an error based on the input information and outputs text information as an investigation result. The investigation processing unit 36 acquires an investigation result output by the LLM 41 and transmits the acquired investigation result to the user terminal device 1. As a result, the user terminal device 1 can display the investigation result of the factor of the error that has occurred at the time of the execution of the application program 21 to be tested and provide the result to the user.

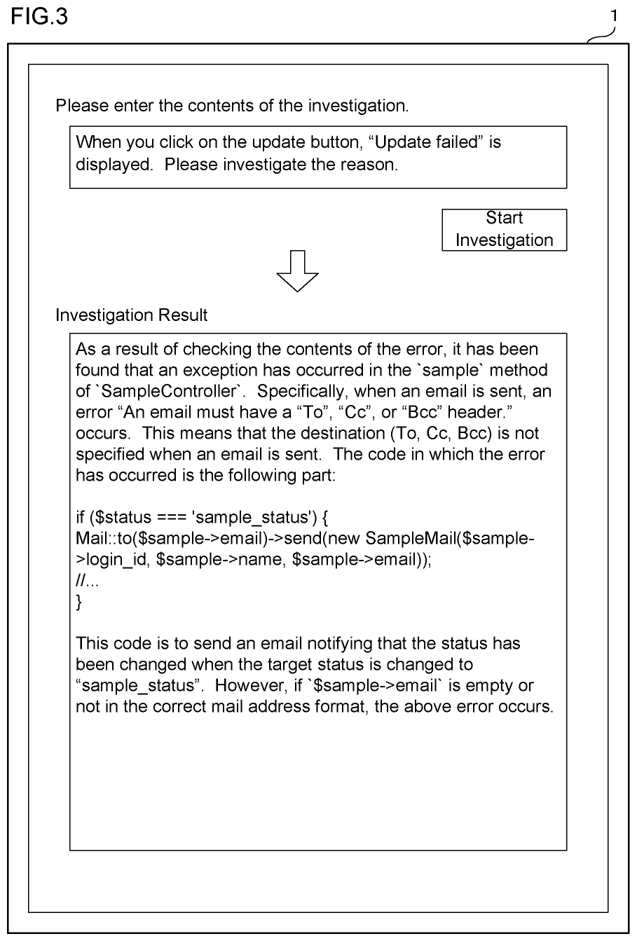

FIG. 3 is a schematic diagram illustrating a display example of an investigation result by the user terminal device 1. In the illustrated display screen of the investigation result, an investigation content input area for the user to input an investigation content is provided in an upper portion of the screen, and an investigation result display area for displaying an investigation result is provided below the investigation content input area. In the investigation content input area, for example, a message “Please enter the contents of the investigation.”, a text box for inputting the investigation content, and a button labeled with “start investigation” are provided. The user can start the investigation of the factor of the error by inputting a sentence of the investigation content into the text box using the keyboard and performing a mouse click operation or the like on the “start investigation” button. The user terminal device 1 acquires the input investigation content and transmits the investigation content to the debugging server device 3 as investigation content information, and accordingly, the debugging server device 3 starts investigation of the factor of the error. At this time, the trace ID of the test case in which the error has occurred may be transmitted from the user terminal device 1 to the debugging server device 3 together with the investigation content information.

In the investigation result display area, a sentence of the investigation result received by the user terminal device 1 from the debugging server device 3 is displayed. In this example, sentences of the following investigation results are displayed. Note that the following investigation results are merely examples, and the present invention is not limited thereto.
“
As a result of checking the contents of the error, it has been found that an exception has occurred in the ‘sample’ method of ‘SampleController’. Specifically, when an email is sent, an error “An email must have a “To”, “Cc”, or “Bcc” header.” occurs. This means that the destination (To, Cc, Bcc) is not specified when an email is sent. The code in which the error has occurred is the following part:
if ($status===‘sample_status’){
Mail::to($sample->email)->send(new SampleMail($sample->login_id, $sample->name,
$sample->email));
// . . .
}
This code is to send an email notifying that the status has been changed when the target status is changed to “sample_status”. However, if ‘$sample->email’ is empty or not in the correct mail address format, the above error occurs.
”

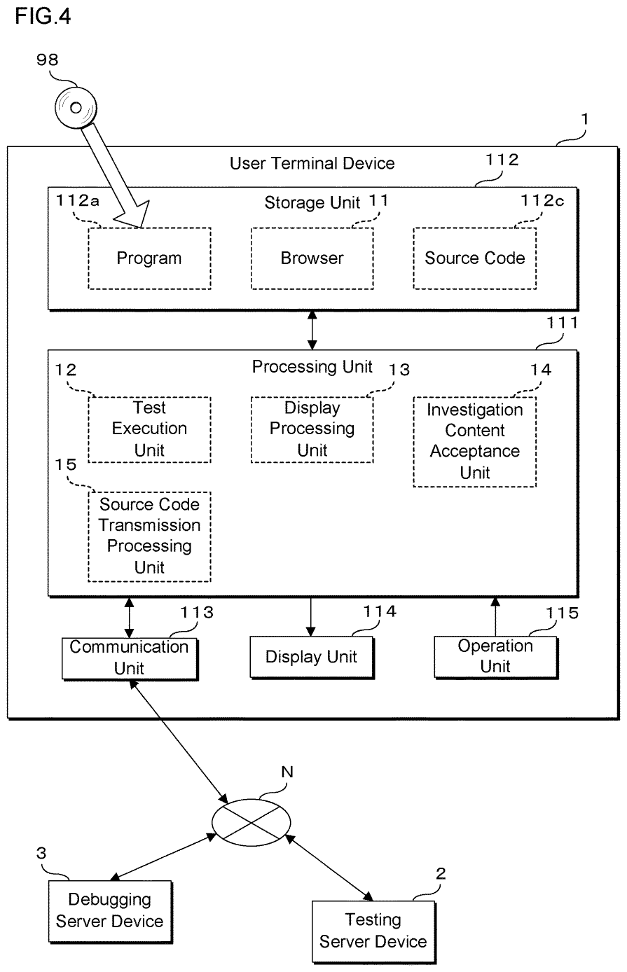

FIG. 4 is a block diagram illustrating a configuration example of the user terminal device 1 according to the present embodiment. The user terminal device 1 according to the present embodiment can be realized, for example, by installing a predetermined program in a general-purpose information processing device such as a personal computer, a smartphone, or a tablet terminal device. The user terminal device 1 according to the present embodiment includes a processing unit 111, a storage unit 112, a communication unit 113, a display unit 114, an operation unit 115, and the like.

The processing unit 111 is configured using an arithmetic processing unit such as a CPU or an MPU, and an ROM or an RAM, and the like. The processing unit 111 reads and executes a program 112a stored in the storage unit 112 to perform various processes such as input and output of information to and from the application program 21 to be tested and collection of the input and output information. The storage unit 112 is configured using a large-capacity storage device such as a hard disk or an SSD. The storage unit 112 stores the program 112a executed by the processing unit 111, and stores the program of the browser 11, the source code 112c of the application program 21 created by the user, and the like. In the present embodiment, the program (computer program, program product) 112a is provided in a manner to be recorded in a recording medium 98, such as a memory card or an optical disc, and the user terminal device 1 reads the program 112a from the recording medium 98 and stores the program in the storage unit 112. However, the program 112a may be provided in a form of distribution via a network.

The communication unit 113 communicates with various devices such as the testing server device 2 and the debugging server device 3 via the network N such as a LAN or the Internet. The display unit 114 is configured using a liquid crystal display or the like, and displays various images, characters, and the like based on processing of the processing unit 111. The operation unit 115 accepts the user's operation and notifies the processing unit 111 of the received operation. For example, the operation unit 115 accepts the user's operation by a mechanical button or an input device such as a touch panel provided on the surface of the display unit 114. Furthermore, for example, the operation unit 115 may be an input device such as a mouse and a keyboard, and these input devices may be configured to be detachable from the user terminal device 1.

In the user terminal device 1 according to the present embodiment, the processing unit 111 reads and executes the program 112a stored in the storage unit 112, and as a result, the test execution unit 12, the display processing unit 13, the investigation content acceptance unit 14, the source code transmission processing unit 15, and the like are realized as software functional units in the processing unit 111. In the present embodiment, information is input to and output from the application program 21 to be tested via the browser 11. The test execution unit 12 is intervening between the front-end program of the application program 21 and the browser 11, and acquires information input to and output from the application program 21 as trace information. The test execution unit 12 attaches a trace ID for identifying a test case to the acquired trace information, and transmits the trace ID and the trace information to the debugging server device 3.

The display processing unit 13 performs processing of displaying various images, characters, and the like on the display unit 114 based on the processing of the processing unit 111. The display processing unit 13 displays, on the display unit 114, a screen illustrated in FIG. 3 for accepting the investigation contents and for displaying the investigation result, for example. The display processing unit 13 displays the investigation result received from the debugging server device 3 on this screen. The investigation content acceptance unit 14 acquires the investigation content input by the user by operating the operation unit 115 on the screen of FIG. 3 displayed by the display processing unit 13, and transmits the investigation content to the debugging server device 3. At this time, the investigation content acceptance unit 14 may transmit the trace ID determined by the test execution unit 12 to the debugging server device 3 together with the investigation content.

The source code transmission processing unit 15 performs processing of transmitting the source code 112c of the application program 21 to be tested to the debugging server device 3 prior to the investigation of the error by the debugging server device 3. The source code transmission processing unit 15 accepts, for example, file selection of the source code 112c from the user, and transmits the selected source code 112c to the debugging server device 3 by the communication unit 113. At this time, the source code transmission processing unit 15 may transmit, for example, version information of the source code 112c or information such as creation date and time information such as a time stamp together with the source code 112c.

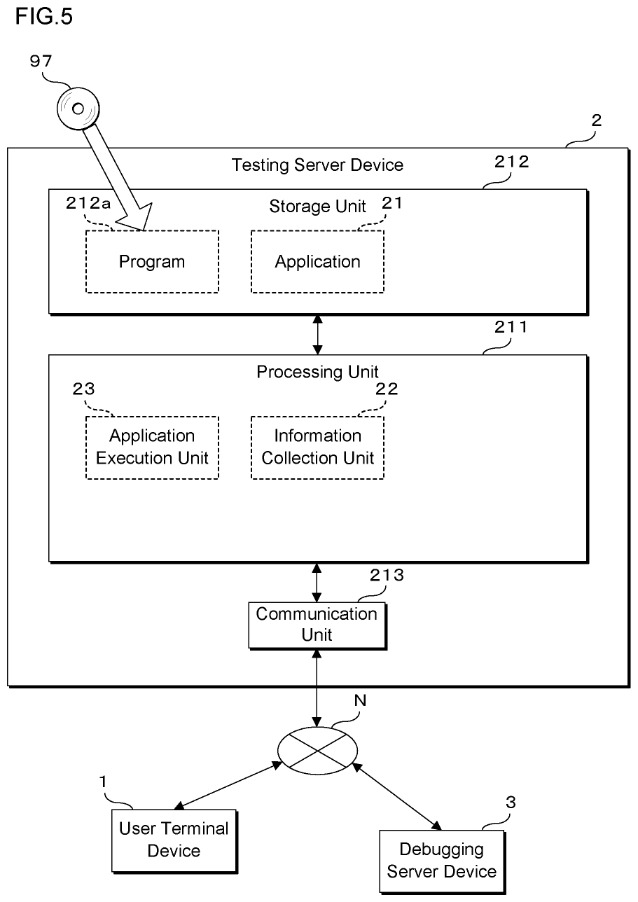

FIG. 5 is a block diagram illustrating a configuration example of the testing server device 2 according to the present embodiment. The testing server device 2 according to the present embodiment can be realized, for example, by installing the computer program according to the present embodiment in an information processing device such as a general-purpose server computer. The testing server device 2 according to the present embodiment includes a processing unit 211, a storage unit 212, a communication unit 213, and the like. The processing unit 211 is configured using an arithmetic processing unit such as a CPU, an MPU, a GPU, an NPU, or a quantum processor, and a storage device such as a ROM and a RAM. The processing unit 211 reads and executes a program 212a stored in the storage unit 212 to perform various processing such as processing for executing the application program 21 to be tested and processing for collecting trace information and log information related to the execution of the application program 21.

The storage unit 212 is configured using a large-capacity storage device such as a hard disk or an SSD. The storage unit 212 stores the program 212a executed by the processing unit 211, the application program 21 to be tested, and the like. In the present embodiment, the program (computer program, program product) 212a is provided in a manner to be recorded in a recording medium 97, such as a memory card or an optical disc, and the testing server device 2 reads the program 212a from the recording medium 97 and stores the program in the storage unit 212. However, the program 212a may be provided in a form of distribution via a network. The application program 21 is a program to be tested created by the user, and may be the same as the source code 112c, or may be an intermediate code, a binary code (object code), or the like obtained by compiling the source code 112c. The communication unit 213 communicates with various devices such as the user terminal device 1 and the debugging server device 3 via the network N such as a LAN or the Internet.

In the testing server device 2 according to the present embodiment, the processing unit 211 reads and executes the program 212a stored in the storage unit 212, and as a result, an application execution unit 23, the information collection unit 22, and the like are realized as software functional units in the processing unit 211. The application execution unit 23 executes the application program 21 to be tested. The application execution unit 23 is, for example, an interpreter that reads and executes a source code, an intermediate code, or the like, and in a case where the application program 21 is executable binary code or the like, the testing server device 2 may not include the application execution unit 23.

The information collection unit 22 collects trace information and log information while the application program 21 is executed. The trace information can include, for example, information such as a function called when the application program 21 is executed, an argument to the function, and a return value of the function, and various types of information such as a value stored in a variable, data stored in a memory, and a value of a register. The log information can include a message such as an error output by the application execution unit 23 that executes the application program 21, a message output by the application program 21, and the like. The information collection unit 22 transmits the trace information and the log information that have been collected to the debugging server device 3 through the communication unit 213. In a case where the trace ID related to the test case executed by the user terminal device 1 is provided, the information collection unit 22 may transmit the trace ID together with the trace information and the log information.

### Flowchart

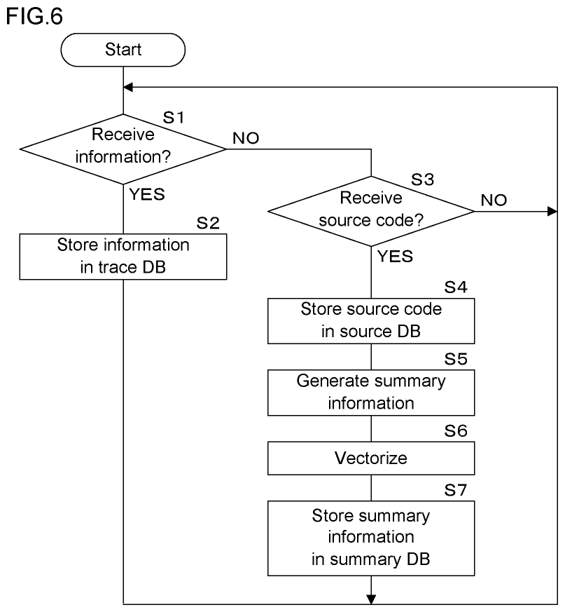

FIG. 6 is a flowchart illustrating an example of a procedure of the information collecting processing performed by the debugging server device 3 according to the present embodiment. The information accumulation unit 31 of the processing unit 311 of the debugging server device 3 according to the present embodiment determines whether the communication unit 313 has received the trace information transmitted from the user terminal device 1, or the trace information and the log information that are transmitted from the testing server device 2 (step S1). When the information is received (S1: YES), the information accumulation unit 31 stores the received information in the trace DB 42 in association with the trace ID (step S2), and the processing returns to step S1.

When the trace information and the log information are not received (S1: NO), the processing unit 311 determines whether the source code 112c of the application program 21 to be tested is received from the user terminal device 1 (step S3). When the source code 112 c is not received (S3: NO), the processing unit 311 returns the processing to step S1. When the source code 112c is received (S3: YES), the processing unit 311 stores the received source code 112c in the source DB 43 (step S4).

Next, the summary generation unit 32 of the processing unit 311 generates summary information of the source code 112c stored in the source DB 43 in step S4 (step S5). At this time, for example, the summary generation unit 32 generates the summary information of the source code 112c by inputting the source code 112c and a prompt including a command for generation of summary information of the source code 112c to the LLM 41, and acquiring the summary information output by the LLM 41. The summary generation unit 32 vectorizes the summary information generated in step S5 (step S6). At this time, the summary generation unit 32 vectorizes the summary information by inputting a text of the summary information to the encoder using, for example, a model of the encoder stored in advance in the model information storage unit 312b, and acquiring vector information output by the encoder. The summary generation unit 32 stores the summary information vectorized in step S6 in the summary DB 44 (step S7), and the processing returns to step S1.

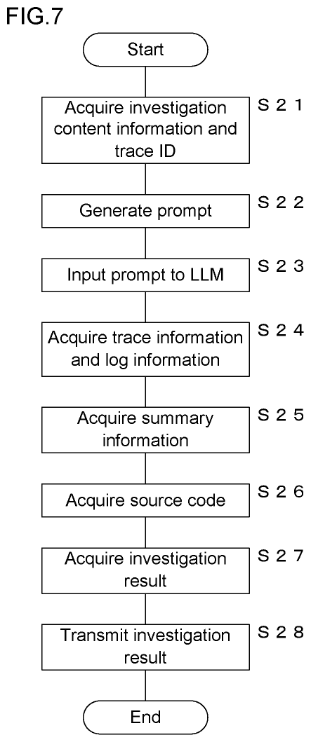

FIG. 7 is a flowchart illustrating an example of a procedure of the investigation processing performed by the debugging server device 3 according to the present embodiment. The investigation processing unit 36 of the processing unit 311 of the debugging server device 3 according to the present embodiment acquires the investigation content information input by the user and the trace ID of the test case in which the error has occurred by receiving the information transmitted from the user terminal device 1 by the communication unit 313 (step S21).

The investigation processing unit 36 generates a prompt including a command for an investigation of the factor of the error based on the investigation content information acquired in step S21 and the trace ID of the test case in which the error has occurred (step S22). At this time, for example, the investigation processing unit 36 generates the prompt by reading a template of a prompt held in advance by the debugging server device 3, and applying information such as the trace ID and the investigation content to the template. The investigation processing unit 36 inputs the prompt generated in step S22 to the LLM 41l (step S23). An example of the prompt input to the LLM 41 in step S23 will be described below.
1. Execute get_trace function based on the provided trace ID to acquire trace information and log information. This task may be executed any number of times.
2. Execute get_program_specification function, for the part considered to be related to the investigation request content, based on the trace information obtained in 1 and the information of the file name obtained from the log information to check the program summary. This task may be executed any number of times.
3. Execute get_program_file function to check the content of the source code file for a part considered to be related to the investigation request content. This task may be executed any number of times.
4. If the cause of the problem can be analyzed by performing the procedure of 1 to 3 above, report the analysis result. If the cause is unknown, repeat 1 to 3 as many times as necessary.
Trace ID: {trace_id}
Investigation Request Content: {input}

Also, the functions described in the example prompts are functions predefined so the LLM 41 can use the functions. For example, the get_trace function is a function that performs processing of acquiring trace information and log information with the trace ID as an input parameter. In response to the call of the get_trace function, the trace reference unit 33 of the processing unit 311 reads information related to the test case of the trace ID from the trace DB 42. In addition, for example, the get_program_specification function is a function that performs processing of acquiring summary information of the source code using the file name of the source code acquired from the trace information and the log information as an input parameter. In response to the call of the get_program_specification function, the summary reference unit 34 of the processing unit 311 reads the information related to the trace information and the log information from the summary DB 44. In addition, for example, the get_program_file function is a function that performs processing of acquiring information of the source code using the file name of the source code acquired from the trace information and the log information as an input parameter. In response to the call of the get_program_file function, the source reference unit 35 of the processing unit 311 reads the source code related to the error of the trace information and the log information from the source DB 43.

The LLM 41 to which the prompt is input in step S23 understands content of the input prompt. Based on item 1 of the above prompt, the LLM 41 considers that “it is necessary to refer to the trace information” as a plan, and executes “get_trace function” as an action to acquire the trace information and the log information corresponding to the trace ID (step S24).

The LLM 41 understands a part considered to be related to the investigation request content from the trace information and the log information acquired in step S24. Based on the above prompt item 2, the LLM 41 considers that “it is necessary to refer to the program summary of the part considered to be related to the investigation request content” as a plan, and executes “get_program_specification function” as an action to acquire the summary information of the program of the part considered to be related to the investigation request content based on the information of the file name acquired from the trace information and the log information (step S25).

The LLM 41 further understands a part considered to be related to the investigation request content from the summary information of the program acquired in step S25. Based on the above prompt item 3, the LLM 41 considers that “it is necessary to refer to the source code of the part considered to be related to the investigation request content” as a plan, and executes “get_program_file function” as an action to acquire the source code of the part considered to be related to the investigation request content based on the information of the file name acquired from the trace information and the log information (step S26).

The LLM 41 further understands a part considered to be related to the investigation request content from the source code acquired in step S26. When it is determined that the cause of the problem has not been analyzed based on the information acquired in steps S24 to S26, the LLM 41 repeatedly executes the processing in steps S24 to S26 to collect further information. When it is determined that the cause of the problem has been analyzed, the LLM 41 considers that “it is necessary to output the analysis result” as a plan and performs “output of analysis result” as an action.

The investigation processing unit 36 acquires information output from the LLM 41 as an investigation result (step S27). The investigation processing unit 36 transmits the investigation result acquired in step S27 to the user terminal device 1 by the communication unit 313 (step S28), and the processing ends.

### Summary

In the information processing system having the above configuration according to the present embodiment, the debugging server device 3 acquires the trace information and the log information that are related to the execution of the application program 21 to be tested, acquires the source code 112c of the application program 21, and acquires the investigation content information indicating contents to be investigated for an error caused by the execution of the application program 21. The debugging server device 3 inputs the trace information, the log information, the source code 112c, and the investigation content information that have been acquired to the LLM 41, acquires the investigation result information output by the LLM 41, and transmits (outputs) the acquired investigation result information to the user terminal device 1. As a result, the information processing system according to the present embodiment can be expected to support debugging work of the application program 21 by the user.

Further, in the information processing system according to the present embodiment, the debugging server device 3 generates the summary information of the source code 112c by the LLM 41 based on the acquired source code 112c. The debugging server device 3 inputs the trace information, the log information, the source code 112c, the investigation content information, and the generated summary information to the LLM 41, and acquires the investigation result information output by the LLM 41. As a result, the information processing system according to the present embodiment can be expected to improve the accuracy of the investigation of the error factor by the LLM 41 by including the summary information of the source code 112c in the information input to the LLM 41.

Moreover, in the information processing system according to the present embodiment, the debugging server device 3 acquires the trace ID for identifying the test case used for the execution of the application program 21, and stores the trace information and the log information in the trace DB 42 in association with the acquired trace ID. The debugging server device 3 reads the trace information and the log information from the trace DB 42 based on the trace ID of the test case in which the error has occurred, and inputs the trace information and the log information that have been read to the LLM 41. As a result, the information processing system according to the present embodiment can be expected to accumulate the trace information and the log information that have been collected along with the execution of the application program 21 to be tested in the trace DB 42, and effectively utilize the accumulated information in the investigation of the factor of the error.

Furthermore, in the information processing system according to the present embodiment, the debugging server device 3 stores the acquired source code 112c in the source DB 43, and stores the generated summary information in the summary DB 44. The debugging server device 3 reads the source code 112c related to the test case in which the error has occurred from the source DB 43, reads the summary information related to the test case in which the error has occurred from the summary DB 44, and inputs the source code 112c and the summary information that have been read to the LLM 41. As a result, the information processing system according to the present embodiment can be expected to accumulate the source code 112c of the application program 21 to be tested and the summary information of the source code 112c in the database, and effectively utilize the accumulated information in the investigation of the factor of the error.

Further, in the information processing system according to the present embodiment, the summary DB 44 of the debugging server device 3 stores information obtained by vectorizing the summary information. As a result, in the information processing system according to the present embodiment, it can be expected that the LLM 41 accumulates the summary information in an easy-to-handle form.

Moreover, in the information processing system according to the present embodiment, the debugging server device 3 generates a prompt including a command for an investigation of an error of the application program 21 based on the trace ID and the investigation content information, and inputs the generated prompt to the LLM 41 together with the trace information, the log information, the source code 112c, and the summary information. As a result, the information processing system according to the present embodiment can be expected to cause the LLM 41 to accurately investigate the factor of the error of the application program 21 to be tested.

According to the present disclosure, it can be expected to support debugging work of an application program by a user.

The embodiment disclosed at present is construed as illustrative in all respects and not restrictive. The scope of the present disclosure is defined not by the above meaning but by the claims, and is intended to include all modifications within the meaning and scope equivalent to the claims.

Matters described in the embodiment can be combined with each other. Further, independent claims and dependent claims described in claims can be combined with each other in all combinations regardless of the form of citation. Furthermore, a form (multi-claim form) in which two or more other claims are recited is used in claims, but the present invention is not limited thereto. The present invention may be described using a form in which multi-claim (multi-multi claim) that cites at least one of multi-claims is recited.

What is claimed is:

1. An information processing method that causes an information processing device to execute the steps comprising:
acquiring trace information and log information relating to execution of an application program to be tested;
acquiring a source code of the application program;
acquiring summary information of the acquired source code;
acquiring investigation content information indicating a content to be investigated regarding an error caused by execution of the application program;
inputting the trace information, the log information, the source code, the summary information, and the investigation content information that have been acquired to a language model;
acquiring investigation result information output by the language model; and
outputting the acquired investigation result information.

2. The information processing method according to claim 1, comprising:
vectorizing summary information of the source code that has been acquired and storing the vectorized summary information in a database;
reading summary information from the database based on the trace information and the log information that have been acquired;
inputting the trace information, the log information, the source code, and the investigation content information that have been acquired, and the summary information that has been read to a language model; and
acquiring an investigation result information output by the language model.

3. The information processing method according to claim 1, comprising:
generating, based on the source code that has been acquired, summary information of the source code by a language model;
inputting the trace information, the log information, the source code, and the investigation content information that have been acquired, and the summary information that has been generated to a language model; and
acquiring an investigation result information output by the language model.

4. The information processing method according to claim 3, comprising:
acquiring identification information of a test case used for execution of the application program;
storing the trace information and log information that have been acquired in a first database in association with the identification information that has been acquired;
reading the trace information and the log information from the first database based on identification information of a test case in which an error has occurred; and
inputting the trace information and the log information that have been read to the language model.

5. The information processing method according to claim 4, comprising:
storing the acquired source code in a second database;
storing the generated summary information in a third database;
reading a source code from the second database, the source code being associated with the test case in which an error has occurred;
reading summary information from the third database, the summary information being related to the test case in which an error has occurred; and
inputting the source code and the summary information that have been read to the language model.

6. The information processing method according to claim 5, wherein the third database stores information obtained by vectorizing the summary information.

7. The information processing method according to claim 4, comprising:
generating a prompt including a command for an investigation of an error of the application program based on the identification information and the investigation content information; and
inputting the generated prompt into the language model.

8. The information processing method according to claim 4, wherein
a first information processing device executes the steps including:
executing the application program;
acquiring the trace information and the log information along with the execution of the application program; and
transmitting the trace information and the log information that have been acquired to a second information processing device, and
the second information processing device executes the steps including:
receiving the trace information and the log information that have been transmitted from the first information processing device; and
storing the trace information and log information that have been received in the first database.

9. A computer program that causes a computer to execute the steps comprising:
acquiring trace information and log information relating to execution of an application program to be tested;
acquiring a source code of the application program;
acquiring summary information of the acquired source code;
acquiring investigation content information indicating a content to be investigated regarding an error caused by execution of the application program;
inputting the trace information, the log information, the source code, the summary information, and the investigation content information that have been acquired to a language model;
acquiring investigation result information output by the language model; and
outputting the acquired investigation result information.

10. An information processing device comprising a processing unit, wherein
the processing unit executes the steps including:
acquiring trace information and log information relating to execution of an application program to be tested;
acquiring a source code of the application program;
acquiring summary information of the acquired source code;
acquiring investigation content information indicating a content to be investigated regarding an error caused by execution of the application program;
inputting the trace information, the log information, the source code, the summary information, and the investigation content information that have been acquired to a language model;
acquiring investigation result information output by the language model; and
outputting the acquired investigation result information.
